(19) United States
(12) Patent Application Publication
(10) Pub. No.: US 2024/0349081 A1
(43) Pub. Date: Oct. 17, 2024

(54) METHOD AND DEVICE FOR EMLSR OPERATION IN WIRELESS LAN

(71) Applicants: HYUNDAI MOTOR COMPANY, Seoul (KR); KIA CORPORATION, Seoul (KR); Korea National University of Transportation Industry-Academic Cooperation Foundation, Chungju-si (KR)

(72) Inventor: Yong Ho Kim, Incheon (KR)

(73) Assignees: HYUNDAI MOTOR COMPANY, Seoul (KR); KIA CORPORATION, Seoul (KR); Korea National University of Transportation Industry-Academic Cooperation Foundation, Chungju-si (KR)

(21) Appl. No.: 18/397,783

(22) Filed: Dec. 27, 2023

Related U.S. Application Data
(63) Continuation of application No. PCT/KR2022/009159, filed on Jun. 27, 2022.

(30) Foreign Application Priority Data
Jun. 28, 2021 (KR) 10-2021-0084279
Jun. 24, 2022 (KR) 10-2022-0077718

(51) Int. Cl. H04W 24/02; H04W 74/08; H04W 74/0816; H04W 84/12

(52) U.S. Cl. CPC H04W 24/02; H04W 74/0816; H04W 74/0866; H04W 84/12

(57) ABSTRACT

Disclosed are a method and device for an EMLSR operation in a wireless LAN. A method of a first device comprises the steps of: receiving a first data frame from a second device via a first link by using a multi-spatial stream; transmitting a reception response frame to the first data frame to the second device via the first link; transmitting a third data frame, including configuration information for transmitting the second data frame, to the second device via the first link; and transmitting the second data frame to the second device via the second link on the basis of the configuration information.

### TECHNICAL FIELD

The present disclosure relates to a wireless local area network (LAN) communication technique, and more particularly, to a technique for transmitting and receiving a frame based on an enhanced multi-link single radio (EMLSR) operation.

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g. 320 MHz bandwidth), multi-link transmission and aggregation operations including multi-band operations, multiple access point (AP) transmission operations, and/or efficient retransmission operations (e.g. hybrid automatic repeat request (HARQ) operations).

However, since a multi-link operation is an operation not defined in the existing wireless LAN specification, detailed operations may need to be defined depending on an environment in which the multi-link operation is performed. In particular, a device (e.g. station (STA)) that supports enhanced multi-link single radio (EMLSR) operations may wait for reception on multiple links. The device that supports EMLSR operations may be referred to as ‘EMLSR device’. When a frame transmission and reception operation is initiated, the EMLSR device may operate on a single link where the frame transmission and reception operation is performed. While the frame transmission and reception operation is performed on a single link, other links may be in a state not capable of performing frame transmission and reception operations. In the EMLSR device, a time for switching a transceiver between links may be required. Accordingly, a method for transmitting and receiving a frame that takes into account the operating characteristics of the EMLSR device on a single link may be required.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for transmitting and receiving frames based on an EMLSR operation in a wireless LAN.

### Technical Solution

A method of a first device, according to a first exemplary embodiment of the present disclosure for achieving the above-described objective, may comprise: receiving a first data frame from a second device on a first link using multiple spatial streams; transmitting a reception response frame for the first data frame to the second device on the first link; transmitting a third data frame including configuration information for transmission of a second data frame to the second device on the first link; and transmitting the second data frame to the second device on a second link based on the configuration information.

The method may further comprise: receiving a multi user (MU)-request-to-send (RTS) frame from the second device on the first link; and transmitting a clear-to-send (CTS) frame to the second device in response to the MU-RTS frame on the first link, wherein the first data frame is received after transmission of the CTS frame.

A reception operation may not be performed on the second link during a first period from a time of transmitting the CTS frame to a completion time of switching radio chain(s) of the first device, and the first period may include (a time required for transmitting CTS frame+a time required for receiving the first data frame+a time required for transmitting the reception response frame+a time required for transmitting the third data frame+a time required for switching the radio chain(s)′.

The reception response frame and the third data frame may be configured in form of an aggregated (A)-medium access control (MAC) protocol data unit (MPDU), and the third data frame may be a quality of service (QOS) Null frame.

The configuration information may include at least one of information indicating a link on which the second data frame is transmitted, information indicating an access category (AC) of the second data frame, or information indicating a scheme of a transmission/reception procedure of the second data frame.

The method may further comprise: in response to that the configuration information indicates that the transmission/reception procedure of the second data frame is performed based on a first scheme, receiving a trigger frame from the second device on the second link, wherein the transmission/reception procedure of the second data frame is initiated by the trigger frame.

The method may further comprise: in response to that the configuration information indicates that the transmission/reception procedure of the second data frame is performed based on a second scheme, receiving an MU-RTS frame from the second device on the second link; and transmitting a CTS frame for the MU-RTS frame to the second device on the second link, wherein the transmission/reception procedure of the second data frame is initiated by the MU-RTS frame.

A method of a second device, according to a second exemplary embodiment of the present disclosure for achieving the above-described objective, may comprise: transmitting a first data frame to a first device on a first link using multiple spatial streams; receiving a reception response frame for the first data frame from the first device on the first link; receiving a third data frame including configuration information for transmission of a second data frame from the first device on the first link; and receiving the second data frame from the first device on a second link based on the configuration information.

The method may further comprise: transmitting a multi user (MU)-request-to-send (RTS) frame to the first device on the first link; and receiving a clear-to-send (CTS) frame for the MU-RTS frame from the first device on the first link, wherein the first data frame is transmitted after reception of the CTS frame.

A reception operation of the first device may not be performed on the second link during a first period from a time of receiving the CTS frame to a completion time of switching radio chain(s) of the first device, and the first period may include (a time required for receiving CTS frame+a time required for transmitting the first data frame+a time required for receiving the reception response frame+a time required for receiving the third data frame+a time required for switching the radio chain(s)′.

The reception response frame and the third data frame may be configured in form of an aggregated (A)-medium access control (MAC) protocol data unit (MPDU), and the third data frame may be a quality of service (QOS) Null frame.

The configuration information may include at least one of information indicating a link on which the second data frame is transmitted, information indicating an access category (AC) of the second data frame, or information indicating a scheme of a transmission/reception procedure of the second data frame.

The method may further comprise: in response to that the configuration information indicates that the transmission/reception procedure of the second data frame is performed based on a first scheme, transmitting a trigger frame to the first device on the second link, wherein the transmission/reception procedure of the second data frame is initiated by the trigger frame.

The method may further comprise: in response to that the configuration information indicates that the transmission/reception procedure of the second data frame is performed based on a second scheme, transmitting an MU-RTS frame to the first device on the second link; and receiving a CTS frame for the MU-RTS frame from the first device on the second link, wherein the transmission/reception procedure of the second data frame is initiated by the MU-RTS frame.

A method of a first device, according to a third exemplary embodiment of the present disclosure for achieving the above-described objective, may comprise: receiving a first data frame from a second device on a first link using multiple spatial streams; transmitting a first reception response frame for the first data frame to the second device on the first link; and in response to that information included in the first data frame indicates that a second data frame to be transmitted to the first device exists in the second device, performing a reception operation on the first link without switching radio chain(s) of the first device.

The method may further comprise: receiving the second data frame from the second device on the first link using the multiple spatial streams; transmitting a second reception response frame for the second data frame to the second device on the first link; and in response to that information included in the second data frame indicates that a third data frame to be transmitted to the first device does not exist in the second device, performing a reception operation on multiple links by switching radio chain(s) of the first device.

A reception operation of the first device may not be performed on the second link while a data frame transmission/reception procedure using the multiple spatial streams is performed on the first link.

The method may further comprise: receiving a multi user (MU)-request-to-send (RTS) frame from the second device on the first link; and transmitting a clear-to-send (CTS) frame for the MU-RTS frame to the second device on the first link, wherein a transmission/reception procedure of the first data frame is initiated by the MU-RTS frame.

A control frame for initiating a transmission/reception procedure of the second data frame may not be used, and the second data frame may be transmitted when a backoff operation succeeds in the second device.

The number of the multiple spatial streams may correspond to the number of radio chains included in the first device.

### Advantageous Effects

According to the present disclosure, an EMLSR device can wait to receive frames on links corresponding to the number of antennas. When a frame is received on a first link among the links, the EMLSR device can switch radio chains to the first link and quickly receive the frame through a plurality of spatial streams. When the frame transmission and reception operation is completed, the EMLSR device can again wait to receive frames from the plurality of links. Accordingly, the EMLSR device can transmit and receive the frame at high speed on a single link using multiple antennas without communication interruption.

### DESCRIPTION OF DRAWINGS

FIG. 1 is a conceptual diagram illustrating a first exemplary embodiment of a wireless LAN system.

FIG. 2 is a block diagram illustrating a first exemplary embodiment of a communication node constituting a wireless LAN system.

FIG. 3 is a conceptual diagram illustrating a first exemplary embodiment of a multi-link configured between multi-link devices (MLDs).

FIG. 4 is a sequence chart illustrating an association procedure of a station in a wireless LAN system.

FIG. 5 is a timing diagram illustrating a first exemplary embodiment of an operation method of a communication node based on EDCA.

FIG. 6 is a block diagram illustrating a first exemplary embodiment of an enhanced multi-link single radio (EMLSR) device in a wireless LAN.

FIG. 7 is a timing diagram illustrating a first exemplary embodiment of a communication method in a device supporting the EMLSR mode.

FIG. 8 is a timing diagram illustrating a second exemplary embodiment of a communication method in a device supporting the EMLSR mode.

FIG. 9 is a timing diagram illustrating a third exemplary embodiment of a communication method in a device supporting the EMLSR mode.

FIG. 10 is a timing diagram illustrating a fourth exemplary embodiment of a communication method in a device supporting the EMLSR mode.

FIG. 11A is a timing diagram illustrating a fifth exemplary embodiment of a communication method in a device supporting the EMLSR mode.

FIG. 11B is a timing diagram illustrating a sixth exemplary embodiment of a communication method in a device supporting the EMLSR mode.

FIG. 12 is a timing diagram illustrating a seventh exemplary embodiment of a communication method in a device supporting the EMLSR mode.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

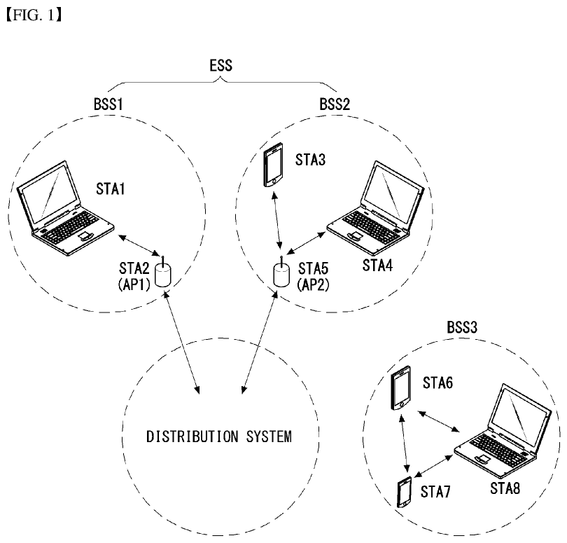

FIG. 1 is a conceptual diagram illustrating a first exemplary embodiment of a wireless LAN system.

As shown in FIG. 1, a wireless LAN system may include at least one basic service set (BSS). A BSS may refer to a set of stations (e.g. STA1, STA2 (AP1), STA3, STA4, STA5 (AP2), STA6, STA7, and STA8) that can communicate with each other through successful synchronization, and may not refer to a specific region. In exemplary embodiments below, a station performing functions as an access point may be referred to as an ‘access point (AP)’, and a station not performing functions as an access point may be referred to as a ‘non-AP station’ or a ‘station’.

The BSS may be classified into an infrastructure BSS and an independent BSS (IBSS). Here, a BSS1 and a BSS2 may mean infrastructure BSSs, and a BSS3 may mean an IBSS. The BSS1 may include a first station (STA1), a first access point (STA2 (AP1)) providing a distribution service, and a distribution system (DS) connecting a plurality of access points (STA2 (AP1) and STA5 (AP2)). In the BSS1, the first access point STA2 (AP1) may manage the first station STA1.

The BSS2 may include a third station (STA3), a fourth station (STA4), a second access point (STA5 (AP2)) providing a distribution service, and a DS connecting the plurality of access points (STA2 (AP1) and STA5 (AP2)). In the BSS2, the second access point STA5 (AP2) may manage the third station STA3 and the fourth station STA4.

The BSS3 may mean an IBSS operating in an ad-hoc mode. An access point, which is a centralized management entity, may not exist in the BSS3. That is, in the BSS3, the stations STA6, STA7, and STA8 may be managed in a distributed manner. In the BSS3, all stations STA6, STA7, and STA8 may refer to mobile stations, and since they are not allowed to access a DS, they may constitute a self-contained network.

The access points STA2 (AP1) and STA5 (AP2) may provide access to the DS for the stations STA1, STA3, and STA4 associated therewith via a wireless medium. In the BSS1 or BSS2, communications between the stations STA1, STA3, and STA4 are generally performed through the access points STA2 (AP1) and STA5 (AP2), but when direct links are established, direct communications between the stations STA1, STA3, and STA4 may be possible.

A plurality of infrastructure BSSs may be interconnected through a DS. The plurality of BSSs connected through the DS may be referred to as an extended service set (ESS). The communication nodes STA1, STA2 (AP1), STA3, STA4, and STA5 (AP2) included in the ESS may communicate with each other, and an arbitrary station (STA1, STA3, or STA4) may move from one BSS to another BSS within the same ESS while communicating without interruption.

The DS may be a mechanism for one access point to communicate with another access point, according to which an access point may transmit frames for stations associated with the BSS it manages, or transmit frames for an arbitrary station that has moved to another BSS. Also, the access point may transmit and receive frames to and from an external network such as a wired network. Such the DS may not necessarily have to be a network, and if it can provide a predetermined distribution service stipulated in the IEEE 802.11 standard, there is no restriction on its form. For example, the DS may be a wireless network such as a mesh network or a physical structure that connects the access points to each other. The communication nodes STA1, STA2 (AP1), STA3, STA4, STA5 (AP2), STA6, STA7, and STA8 included in the wireless LAN system may be configured as follows.

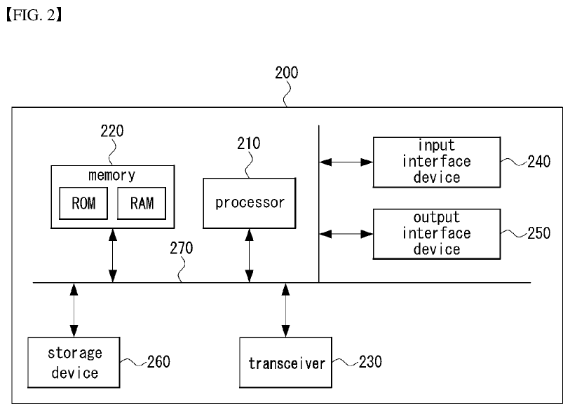

FIG. 2 is a block diagram illustrating a first exemplary embodiment of a communication node constituting a wireless LAN system.

As shown in FIG. 2, a communication node 200 may include at least one processor 210, a memory 220, and a transceiver 230 connected to a network to perform communications. The transceiver 230 may be referred to as a transceiver, a radio frequency (RF) unit, an RF module, or the like. In addition, the communication node 200 may further include an input interface device 240, an output interface device 250, a storage device 260, and the like. The respective components included in the communication node 200 may be connected by a bus 270 to communicate with each other.

However, the respective components included in the communication node 200 may be connected through individual interfaces or individual buses centering on the processor 210 instead of the common bus 270. For example, the processor 210 may be connected to at least one of the memory 220, the transceiver 230, the input interface device 240, the output interface device 250, and the storage device 260 through a dedicated interface.

The processor 210 may execute program commands stored in at least one of the memory 220 and the storage device 260. The processor 210 may refer to a central processing unit (CPU), a graphics processing unit (GPU), or a dedicated processor on which the methods according to the exemplary embodiments of the present invention are performed. Each of the memory 220 and the storage device 260 may be configured as at least one of a volatile storage medium and a nonvolatile storage medium. For example, the memory 220 may be configured with at least one of a read only memory (ROM) and a random access memory (RAM).

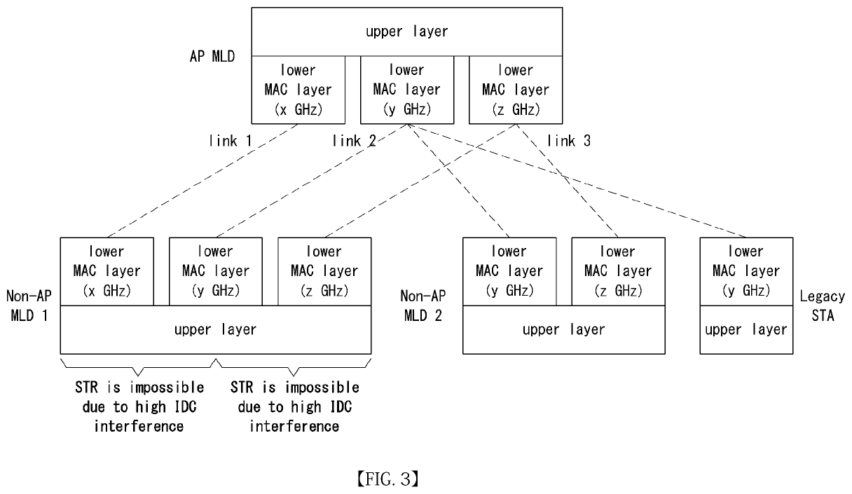

FIG. 3 is a conceptual diagram illustrating a first exemplary embodiment of a multi-link configured between multi-link devices (MLDs).

As shown in FIG. 3, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g. STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links by using a non-contiguous bandwidth extension scheme (e.g. 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 210 shown in FIG. 2). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 210 shown in FIG. 2).

The MLD may perform communications in multiple bands (i.e., multi-band). For example, the MLD may perform communications using a 40 MHz bandwidth according to a channel expansion scheme (e.g. bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g. one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g. AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g. STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g. IEEE 802.11a/b/g/n/ac/ax STA) may be connected to one or more links of the multi-link supported by the AP MLD.

Each of the AP MLD and the STA MLD may have an MLD MAC address, and each of the AP and the STA operating in each link may have a MAC address. The MLD MAC address of the AP MLD may be referred to as an AP MLD MAC address, and the MLD MAC address of the STA MLD may be referred to as a STA MLD MAC address. The MAC address of the AP may be referred to as an AP MAC address, and the MAC address of the STA may be referred to as a STA MAC address. In a multi-link negotiation procedure, the AP MLD MAC address and the STA MLD MAC address may be used. The address of the AP and the address of the STA may be exchanged and/or configured in the multi-link negotiation procedure.

When the multi-link negotiation procedure is completed, the AP MLD may generate an address table and manage and/or update the address table. One AP MLD MAC address may be mapped to one or more AP MAC addresses, and corresponding mapping information may be included in the address table. One STA MLD MAC address may be mapped to one or more STA MAC addresses, and corresponding mapping information may be included in the address table. The AP MLD may identify address information based on the address table. For example, when a STA MLD MAC address is received, the AP MLD may identify one or more STA MAC addresses mapped to the STA MLD MAC address based on the address table.

In addition, the STA MLD may manage and/or update the address table. The address table may include ‘mapping information between the AP MLD MAC address and the AP MAC address(es)’ and/or ‘mapping information between the STA MLD MAC address and the STA MAC address(es)’. The AP MLD may receive a packet from a network, identify an address of a STA MLD included in the packet, identify link(s) supported by the STA MLD, and may identify STA(s) taking charge of the link(s) from the address table. The AP MLD may set STA MAC address(es) of the identified STA(s) as receiver address(es), and may generate and transmit frame(s) including the receiver address(es).

Meanwhile, an association procedure in a wireless LAN system may be performed as follows.

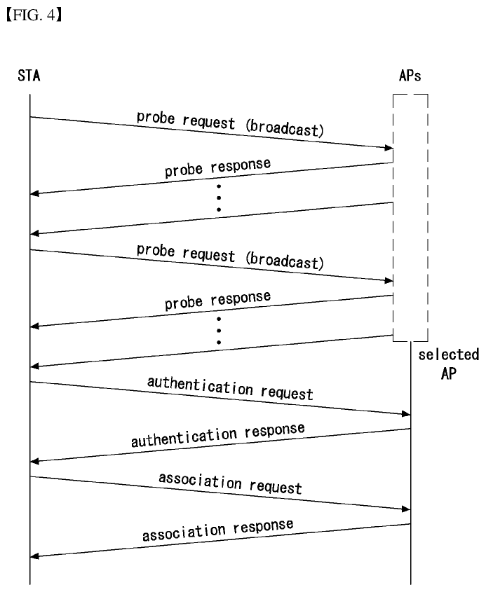

FIG. 4 is a sequence chart illustrating an association procedure of a station in a wireless LAN system.

As shown in FIG. 4, an association procedure of a STA in an infrastructure BSS may generally be divided into a probe step of detecting AP(s), an authentication step with detected AP(s), and an association step with the authenticated AP(s). The STA may be a STA MLD or a STA affiliated with the STA MLD, and the AP may be an AP MLD or an AP affiliated with the AP MLD.

The STA may detect neighboring APs using a passive scanning scheme or an active scanning scheme. When the passive scanning scheme is used, the STA may detect neighboring APs by overhearing beacons transmitted by APs. When the active scanning scheme is used, the STA may transmit a probe request frame, and may detect neighboring APs by receiving probe response frames that are responses to the probe request frame from the APs.

When the neighboring APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard, and may complete authentication with the AP by receiving an authentication response frame that is a response to the authentication request frame from the AP.

When the authentication with the AP is completed, the STA may perform an association step with the AP. In this case, the STA may select one AP among AP(s) with which the STA has performed the authentication step, and perform the association step with the selected AP. That is, the STA may transmit an association request frame to the selected AP, and may complete the association with the selected AP by receiving an association response frame that is a response to the association request frame from the selected AP.

Meanwhile, communication nodes (e.g. access points, stations, and the like) belonging to the wireless LAN system may perform transmission and reception operations of frames based on a point coordination function (PCF), hybrid coordination function (HCF), HCF controlled channel access (HCCA), distributed coordination function (DCF), enhanced distributed channel access (EDCA), and/or the like.

In the wireless LAN system, frames may be classified into a management frame, a control frame, and a data frame. The management frame may include an association request frame, association response frame, reassociation request frame, reassociation response frame, probe request frame, probe response frame, beacon frame, disassociation frame, authentication frame, deauthentication frame, action frame, and the like.

The control frame may include an acknowledgment (ACK) frame, block ACK request (BAR) frame, block ACK (BA) frame, power saving (PS)-Poll frame, request-to-send (RTS) frame, clear-to-send (CTS) frame, and the like. The data frame may be classified into a quality of service (QOS) data frame and a non-QoS data frame. The QoS data frame may refer to a data frame for which transmission according to a QoS is required, and the non-QoS data frame may indicate a data frame for which transmission according to a QoS is not required. The QoS data frame may include a QOS Null frame, and the QoS Null frame may not include a payload.

Meanwhile, in a wireless LAN system, a communication node (e.g. access point or station) may operate based on the EDCA scheme.

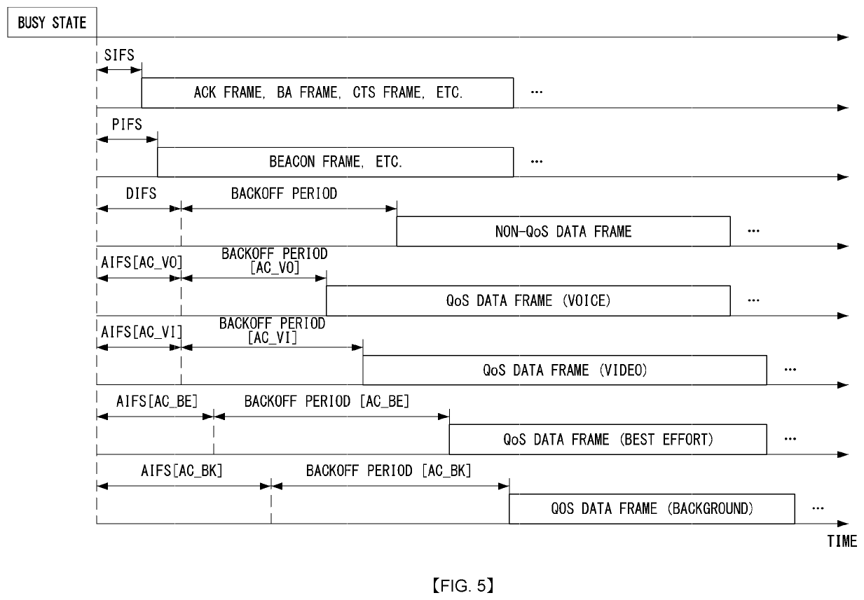

FIG. 5 is a timing diagram illustrating a first exemplary embodiment of an operation method of a communication node based on EDCA.

As shown in FIG. 5, a communication node desiring to transmit a control frame (or a management frame) may perform a channel state monitoring operation (e.g. carrier sensing operation) during a predetermined period (e.g. short interframe space (SIFS) or PCF IFS (PIFS)), and when the channel state is determined to be idle during the predetermined period (e.g. SIFS or PIFS), the communication node may transmit the control frame (or the management frame). For example, the communication node may transmit an ACK frame, a BA frame, a CTS frame, or the like when the channel state is determined to be idle during SIFS. Also, the communication node may transmit a beacon frame or the like when the channel state is determined to be idle during the PIFS. On the other hand, when it is determined that the channel state is busy during the predetermined period (e.g. SIFS or PIFS), the communication node may not transmit the control frame (or the management frame). Here, the carrier sensing operation may refer to a clear channel assessment (CCA) operation.

A communication node desiring to transmit a non-QoS data frame may perform a channel state monitoring operation (e.g. carrier sensing operation) during DCF IFS (DIFS), and when the channel state is determined to be idle during the DIFS, the communication node may perform a random backoff procedure. For example, the communication node may select a backoff value (e.g. a backoff counter) within a contention window according to the random backoff procedure and may perform a channel state monitoring operation (e.g. carrier sensing operation) during a period corresponding to the selected backoff value (hereinafter, referred to as ‘backoff period’). The communication node may transmit the non-QoS data frame when the channel state is determined to be idle in the backoff period.

A communication node desiring to transmit a QoS data frame may perform a channel state monitoring operation (e.g. carrier sensing operation) during an arbitration IFS (AIFS), and when the channel state is determined to be idle during the AIFS, the communication node may perform a random backoff procedure. The AIFS may be configured according to an access category (AC) of a data unit (e.g. protocol data unit (PDU)) included in the QoS data frame. The AC of the data unit may be as shown in Table 1 below.

TABLE 1

| Priority | AC | Description |
|---|---|---|
| Lowest | AC_BK | Background |
| | AC_BE | Best effort |
| | AC_VI | Video |
| Highest | AC_VO | Voice |

AC_BK may indicate background data, AC_BE may indicate data transmitted in the best effort manner, AC_VI may indicate video data, AC_VO may indicate voice data. For example, the length of the AIFS for the QoS data frame corresponding to each of AC_VO and AC_VI may be configured to be equal to the length of the DIFS. The length of the AIFS for the QoS data frame corresponding to each of AC_BE and AC_BK may be configured to be longer than the length of the DIFS. Here, the length of the AIFS for the QoS data frame corresponding to AC_BK may be configured to be longer than the length of the AIFS for the QoS data frame corresponding to AC_BE. In the random backoff procedure, the communication node may select a backoff value (e.g. a backoff counter) within a contention window according to the AC of the QoS data frame. The contention window according to the AC may be as shown in Table 2 below. CWₘᵢₙ may indicate a minimum value of the contention window, CWₘₐₓ may indicate a maximum value of the contention window, and each of the minimum value and the maximum value of the contention window may be represented by the number of slots.

TABLE 2

| AC | CWₘᵢₙ | CWₘₐₓ |
|---|---|---|
| AC_BK | 31 | 1023 |
| AC_BE | 31 | 1023 |
| AC_VI | 15 | 31 |
| AC_VO | 7 | 15 |

The communication node may perform a channel state monitoring operation (e.g. carrier sensing operation) in the backoff period and may transmit the QoS data frame when the channel state is determined to be idle in the backoff period.

Hereinafter, data transmission and reception methods in a wireless LAN system will be described. Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a STA is described, an AP corresponding thereto may perform an operation corresponding to the operation of the STA. Conversely, when an operation of an AP is described, a STA corresponding thereto may perform an operation corresponding to the operation of the AP. In exemplary embodiments, operations of a STA may be interpreted as operations of a STA MLD, operations of a STA MLD may be interpreted as operations of a STA, operations of an AP may be interpreted as operations of an AP MLD, and operations of an AP MLD may be interpreted as operations of an AP.

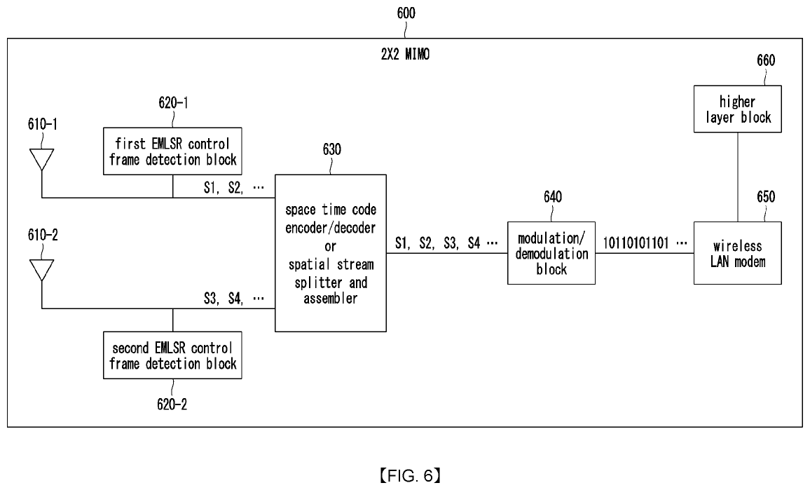

FIG. 6 is a block diagram illustrating a first exemplary embodiment of an enhanced multi-link single radio (EMLSR) device in a wireless LAN.

As shown in FIG. 6, an EMLSR device 600 may be an MLD supporting MLSR operations and/or EMLSR operations. The EMLSR device 600 may be referred to as an MLSR device. An EMLSR STA (or MLSR STA) may be a STA supporting MLSR operations and/or EMLSR operations, and an EMLSR AP (or MLSR AP) may be an AP supporting MLSR operations and/or EMLSR operations. The MLSR operation may mean an MLSR mode, and the EMLSR operation may mean an EMLSR mode. The EMLSR device 600 may include antennas 610-1 and 610-2, EMLSR control message detection blocks 620-1 and 620-2, a spatial stream processing block 630, a modulation and demodulation block 640, a wireless LAN modem 650, and/or a higher layer block 660. In exemplary embodiments, a spatial stream may be referred to as ‘SS’.

The EMLSR device 600 may include the plurality of antennas 610-1 and 610-2. The first antenna 610-1 may be used for a sensing operation and/or a reception operation of signals on a first link. The second antenna 610-2 may be used for a sensing operation and/or a reception operation of signals on a second link. A frequency at which the first link operates may be different from a frequency at which the second link operates. The sensing operation and/or reception operation performed by the first antenna and/or the second antenna may be referred to as ‘listening operation’. In order to simultaneously receive spatial stream signals, the first antenna 610-1 and the second antenna 610-2 may perform sensing operations and/or reception operations of signals on one of the first link and the second link. Among the plurality of antennas 610-1 and 610-2 included in the EMLSR device 600, one antenna may be a primary antenna, and the remaining antenna(s) may be secondary antenna(s). The primary antenna and secondary antenna(s) may be configured in advance. Alternatively, the primary antenna and the secondary antenna(s) may be configured in a negotiation procedure between the EMLSR device 600 and another device (e.g. AP MLD supporting EMLSR operations). An antenna performing a listening operation on a link having a low number (e.g. low index) may be configured as the primary antenna, and the remaining antenna(s) may be configured as the secondary antenna(s).

The first EMLSR control frame detection block 620-1 may be connected to or cooperate with the first antenna 610-1, and the second EMLSR control frame detection block 620-2 may be connected to or cooperate with the second antenna 610-2. Electromagnetic waves (e.g. signals) detected by the antennas 610-1 and 610-2 may be input to the EMLSR control frame detection blocks 620-1 and 620-2. The EMLSR control frame detection blocks 620-1 and 620-2 may determine whether the electromagnetic wave (e.g. signal) corresponds to a specific control frame (e.g. initial control frame). The EMLSR control frame detection blocks 620-1 and 620-2 may support only a predefined modulation and coding scheme (MCS) and may identify only predefined control frame formats. The formats of the predefined control frames (e.g. specific control frame, initial control frame) may include a request-to-send (RTS) frame, a multi-user (MU)-RTS trigger frame, and/or a buffer status report poll (BSRP) trigger frame.

When a specific control frame is detected by the EMLSR control frame detection blocks 620-1 and/or 620-2, the EMLSR device 600 may perform a reception operation for receiving data through multiple SSs by simultaneously using as many spatial streams as the number of spatial streams (e.g. the number of antennas) supported by the EMLSR device 600. In order to perform the reception operation for simultaneously receiving multiple spatial streams, a clear-to-send (CTS) frame may be transmitted through the first antenna 610-1 after a short inter-frame space (SIFS) from a time of detecting the specific control frame on the first link, and the second antenna 610-2 operating on the second link on which the specific control frame is not detected, may switch to the first link and operate on the first link. In other words, a reception radio chain (i.e., RX radio chain) may be switched to operate on the first link. In the present disclosure, the RX radio chain may refer to a radio chain. In addition, in the present disclosure, the radio chain may refer to an RX radio chain or an RX chain. The radio chain may refer to a radio frequency (RF) chain. Switching of an operating link of the second antenna 610-2 (e.g. switching of the radio chain) may start after the time of detecting the specific control frame on the first link, and may be completed until a SIFS elapses after transmitting the CTS signal after a SIFS elapses. Thereafter, multiple spatial streams (e.g. two spatial streams) may be received through the plurality of antennas 610-1 and 610-2. The operation of receiving the MU-RTS trigger frame and the operation of switching the radio chain to receive multiple spatial streams may be referred to as ‘EMLSR operation’.

When a signal is detected by one of the plurality of antennas 610-1 and 610-2, and the signal is determined by the EMLSR control frame detection blocks 620-1 and 620-2 not to be the specific control frame, the signal may be delivered to the modulation/demodulation block 640 without going through the spatial stream processing block 630. The one antenna detecting the signal may be the primary antenna.

When the specific control frame is detected by the EMLSR control frame detection blocks 620-1 and 620-2, and the reception procedure for the multiple spatial streams is performed, the spatial stream processing block 630 may perform a rearrangement operation for signals (e.g. symbols) received through the plurality of antennas 610-1 and 610-2. When a space time code is used, a single symbol may be generated into a plurality of symbols by a coding operation, and the plurality of symbols may be transmitted. The space time code may be an Alamouti code. The spatial stream processing block 630 may perform an operation of restoring the redundant symbols into the single symbol in a decoding procedure.

The output symbols of the spatial stream processing block 630 may be input to the modulation/demodulation block 640. The modulation/demodulation block 640 may generate bits by performing a demodulation operation on the symbols. The modulation/demodulation block 640 may perform a channel coding operation and/or a channel decoding operation. The output bits of the modulation/demodulation block 640 may be delivered to the wireless LAN modem 650. The wireless LAN modem 650 may perform medium access control (MAC) operations defined in the IEEE 802.11 standards. An output of the wireless LAN modem 650 may be delivered to the higher layer block 660. The higher layer block 660 may perform higher layer operations defined in the IEEE 802.11 standards. A series of operations performed after the specific control frame is detected by the EMLSR control frame detection block may be operations performed during the EMLSR operation.

In the EMLSR device 600, a transmission operation may be performed in the reverse order of the above-described reception operation.

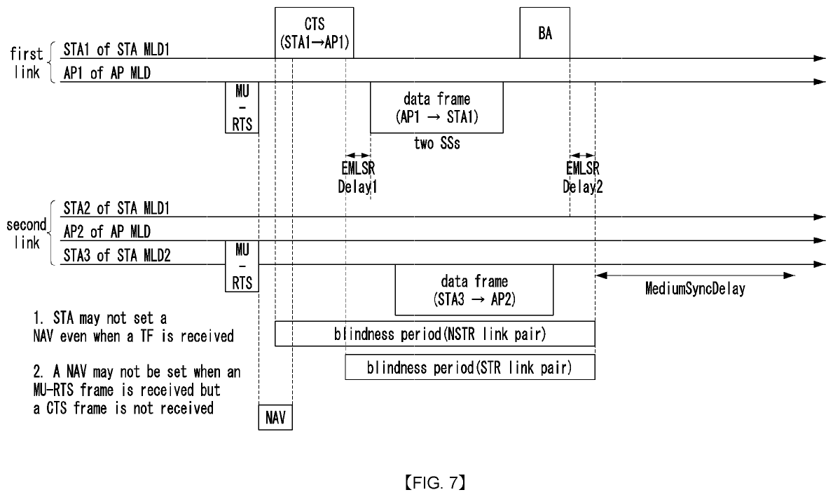

FIG. 7 is a timing diagram illustrating a first exemplary embodiment of a communication method in a device supporting the EMLSR mode.

As shown in FIG. 7, AP MLD(s) and STA MLD(s) may support the EMLSR mode. In exemplary embodiments, a STA MLD may mean a STA MLD1 and/or STA MLD2. A frame transmission and reception procedure between an AP MLD and the STA MLD may be initiated by a specific control frame (e.g. MU-RTS frame) agreed between the AP MLD and the STA MLD. The AP MLD may initiate a multi-spatial stream transmission procedure by transmitting a multi user-request-to-send

(MU-RTS) frame on one of a plurality of links. In this case, a channel state of each link may not be considered. Therefore, the AP MLD may transmit MU-RTS frames on multiple available links. The STA MLD1 may receive MU-RTS frame(s) from the AP MLD. The STA MLD1 may select a link (e.g. first link) with the best reception status (e.g. best reception quality) among link(s) on which the MU-RTS frame(s) are received, and transmit a clear-to-send (CTS) frame on the selected link.

The STA MLD1 may perform a radio chain switching operation from a tine of selecting the link. The STA MLD1 may receive the MU-RTS frame(s) and transmit the CTS frame for the MU-RTS frame. The STA MLD1 may receive a frame (e.g. data frame) through the link (e.g. first link) on which the STA MLD1 transmits the CTS frame by using a plurality of spatial streams (e.g. two spatial streams). The number of the plurality of spatial streams may correspond to the number of radio chains included in the STA MLD1. When performing the radio chain switching operation, it may take a time of EMLSR Delay1 in the STA MLD1. In exemplary embodiments, the data frame may be a data unit, a physical protocol data unit (PPDU) or a PPDU frame, or a medium access control layer (MAC) protocol data unit (MPDU).

The STA MLD1 (e.g. STA1) may receive the data frame from the AP MLD (e.g. AP1) on the first link, and may transmit a reception response frame after an SIFS elapses from a time of receiving the data frame. In exemplary embodiments, the reception response frame may be an acknowledgment (ACK) frame or a block ACK (BA) frame. The STA MLD1 may transmit the reception response frame by using two or more spatial streams or one spatial stream.

After the frame transmission and reception procedure (e.g. after transmission of the reception response frame), the STA MLD1 may restore the switched radio chains to original links to wait for reception of MU-RTS frame(s) on the plurality of links. When restoring the radio chains to the original links, it may take a time of EMLSR delay2 in the STA MLD1. The EMLSR device may receive MU-RTS frame(s) after the time of EMLSR Delay2 elapses after transmission of the reception response frame on the second link. In exemplary embodiment, the operation (e.g. reception operation) of waiting to receive a frame may mean an operation of monitoring a link (or channel) to receive the frame.

The AP1 may transmit the MU-RTS frame on the first link, and the AP2 may transmit the MU-RTS frame on the second link. The STA1 may initiate a data frame transmission and reception procedure by transmitting a CTS frame on the first link. A medium access control (MAC) header of the MU-RTS frame may include a duration field. Other communication nodes (e.g. MLD, AP, STA) may set a network allocation vector (NAV) to a time corresponding to a value of the duration field, and may not perform a transmission operation during a time corresponding to the set NAV. The duration field included in the MAC header of the MU-RTS frame may be set to indicate a period including the time required for the STA MLD to transmit the reception response frame.

Although the AP2 of AP MLD transmitted the MU-RTS frame on the second link, the STA1 of STA MLD1 transmits the CTS frame on the first link, so a NAV does not need to be set on the second link. Accordingly, STA(s) may wait on the second link during a time of (SIFS+a time required for detecting a preamble of a frame (e.g. data frame)) after receiving the MU-RTS frame, and may release the NAV if a preamble of a frame is not detected. The time required for detecting the preamble of the frame may be substituted with a time required for detecting the MAC header or a time required for transmitting the CTS frame.

When the STA1 of STA MLD1 transmits the CTS frame on the first link and performs the radio chain switching operation, the second link may be in a state in which reception of a frame (e.g. data frames) is not possible. That is, a channel sensing operation may not be performed on the second link. The above-described state (i.e. a link state when the EMLSR operation is performed) may be the same or similar to a state of a blindness period in a non-simultaneous transmit and receive (NSTR) link pair. When the first link and the second link are an NSTR link pair, the blindness period on the second link may start from a time of transmitting the CTS frame on the first link even when the radio chain switching operation is not performed. When the first link and the second link are an STR link pair, the blindness period on the second link may start from a time of performing the radio chain switching operation. An end time of the blindness period may be a time when transmission of the reception response frame and restoration of the radio chains are completed. The end time of the blindness period may be a time after the time of EMLSR Delay2 elapses from the time of transmitting the reception response frame. Since a channel sensing operation is not performed during the blindness period on the second link, a MediumSyncDelay timer may operate. The MediumSyncDelay timer may be start after the blindness period ends. A transmission operation may not be performed during a time corresponding to the MediumSyncDelay timer. A channel sensing operation may be performed during a time corresponding to the MediumSyncDelay timer.

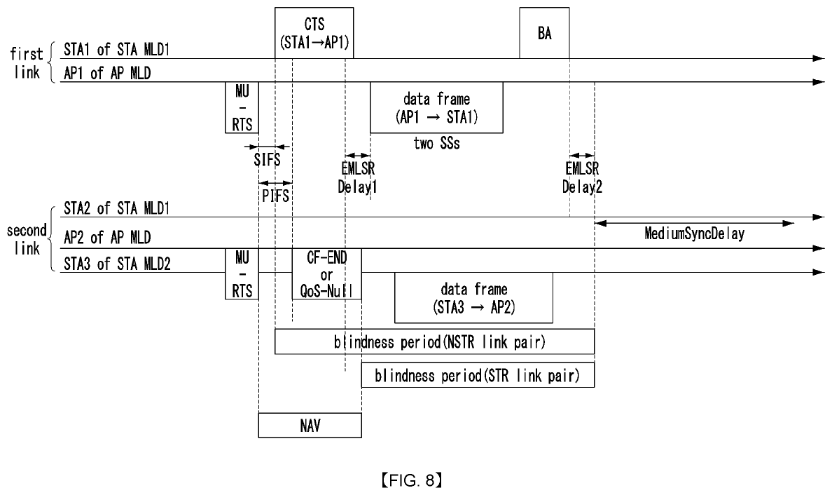

FIG. 8 is a timing diagram illustrating a second exemplary embodiment of a communication method in a device supporting the EMLSR mode.

As shown in FIG. 8, AP MLD(s) and STA MLD(s) may support the EMLSR mode. In exemplary embodiments, an STA MLD may mean an STA MLD1 and/or STA MLD2. The AP1 may transmit an MU-RTS frame on the first link, and the AP2 may transmit an MU-RTS frame on the second link. The STA1 may initiate a data frame transmission and reception procedure by transmitting a CTS frame on the first link in response to the MU-RTS frame. A MAC header of the MU-RTS frame may include a duration field. Other communication nodes (e.g. MLD, AP, STA) may set a NAV to a time corresponding to a value of the duration field, and may not perform a transmission operation during a time corresponding to the set NAV. The duration field included in the MAC header of the MU-RTS frame may be set to indicate a period including a time required for the STA MLD to transmit a reception response frame.

Although theAP2 of AP MLD transmitted the MU-RTS frame on the second link, the STA1 of STA MLD1 transmits the CTS frame on the first link, so a NAV does not need to be set on the second link. To release an unnecessarily set NAV, the AP2 of AP MLD1 may transmit a CF-END frame or a QoS Null frame (e.g. QoS Null data frame) including a duration field set to 0 on the second link. The AP2 may transmit the CF-END frame or QoS Null frame after identifying that a CTS frame is not transmitted on the second link. Accordingly, the AP2 may transmit the CF-END frame or QoS Null frame on the second link when the CTS frame is received on the first link. A time at which the AP2 can transmit the CF-END frame or QoS Null frame on the second link may be immediately after a time of detecting the CTS frame. The time of detecting the CTS frame may be a time of detecting a preamble of the frame (e.g. PPDU frame, CTS frame), a time of detecting a MAC header of the CTS frame, or a time of the entire transmission of the CTS frame.

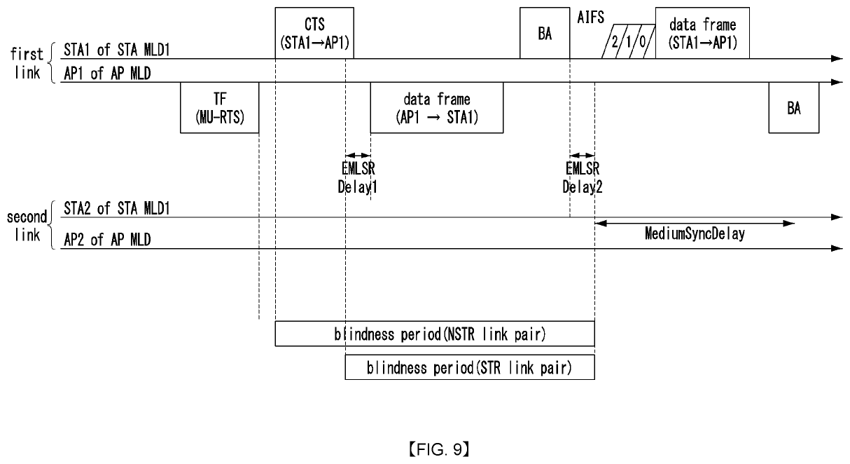

FIG. 9 is a timing diagram illustrating a third exemplary embodiment of a communication method in a device supporting the EMLSR mode.

As shown in FIG. 9, AP MLD(s) and STA MLD(s) may support the EMLSR mode. The AP1 of AP MLD may transmit an MU-RTS frame on the first link. The STA1 of STA MLD may receive the MU-RTS frame from the AP1 on the first link and transmit a CTS frame on the first link in response to the MU-RTS frame. The AP1 may receive the CTS frame from the STA1 on the first link. According to the above-described operation, a frame transmission and reception procedure based on an EMLSR operation using multiple spatial streams (hereinafter referred to as ‘EMLSR communication procedure’) may be initiated. Accordingly, a procedure for transmitting and receiving a frame (e.g. data frame, reception response frame) may be performed between the AP MLD and the STA MLD. The number of multiple spatial streams may correspond to the number of radio chains included in the STA MLD.

When a data unit (e.g. data, packet) exists in a queue of the STA MLD while performing the EMLSR communication procedure, a procedure of transmitting and receiving a data frame may be initiated using one link of multiple links after the EMLSR communication procedure. After the EMLSR communication procedure, a time MediumSyncDelay may be set (e.g. a MediumSyncDelay timer is set) on the second link. Accordingly, transmission of data or frame on the second link may not be performed during a time corresponding to the timer. Since the EMLSR communication procedure is performed on the first link, MediumSyncDelay is not set on the first link, and the frame transmission and reception procedure can be performed using multiple spatial streams in multiple radio chains, the data frame can be transmitted only on the first link. To transmit the data frame, the STA1 may perform a backoff operation after an arbitrary interframe space (AIFS) according to an access category (AC) of the data frame elapses from a time of transmitting a reception response frame (e.g. BA frame). When the backoff operation succeeds, the STA1 may transmit the data frame using multiple spatial streams (e.g. two spatial streams). After transmitting the data frame, the STA1 may receive a reception response frame for the data frame from the AP1.

When the first link and the second link are an NSTR link pair, MediumSyncDelay may be released in the STA2 during a time required for the STA1 to transmit the data frame on the first link. The time required for the STA1 to transmit the data frame on the first link may be a blindness period on the second link. A channel sensing operation may not be performed in the blindness period. The STA2 may set MediumSyncDelay again after the blindness period. Even when the first link and the second link are an STR link pair (e.g. when the first link and the second link are not an NSTR link pair), since the STA MLD is an EMLSR STA MLD (e.g. EMLSR STA), the time for the STA MLD to transmit the data frame on the first link may be a blindness period on the second link. Accordingly, MediumSyncDelay may be set on the second link.

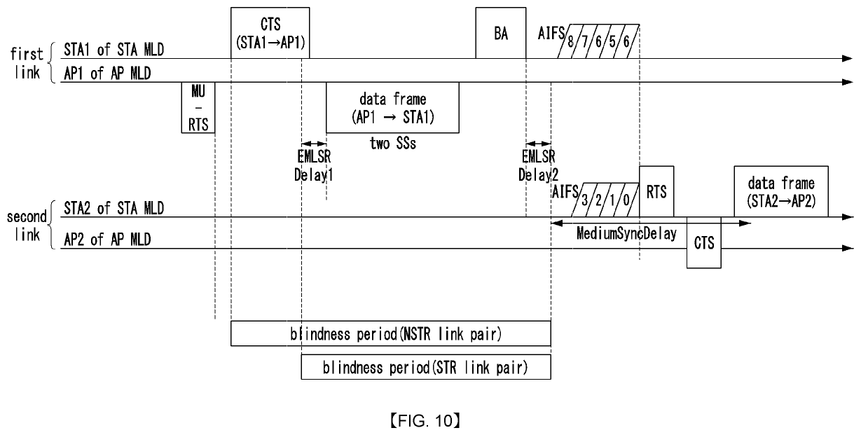

FIG. 10 is a timing diagram illustrating a fourth exemplary embodiment of a communication method in a device supporting the EMLSR mode.

As shown in FIG. 10, AP MLD(s) and STA MLD(s) may support the EMLSR mode. The AP1 of AP MLD may transmit an MU-RTS frame on the first link. The STA1 of STA MLD may receive the MU-RTS frame from the AP1 on the first link and transmit a CTS frame on the first link in response to the MU-RTS frame. The AP1 may receive the CTS frame from the STA1 on the first link. According to the above-described operation, a frame transmission and reception procedure based on an EMLSR operation using multiple spatial streams (i.e., EMLSR communication procedure) may be initiated. Accordingly, a procedure for transmitting and receiving a frame (e.g. data frame, reception response frames) may be performed between the AP MLD and the STA MLD. The number of multiple spatial streams may correspond to the number of radio chains included in the STA MLD.

When a data unit (e.g. data, packet, MPDU, PPDU) exists in a queue while performing the EMLSR communication procedure, a procedure for transmitting and receiving a data frame may be initiated using one link of multiple links after the EMLSR communication procedure. A traffic identifier (TID) may be determined according to an AC of the data frame, and a link on which the data frame is transmitted may be determined based on TID-to-link mapping. For example, the link on which the data frame is transmitted may be determined to be the second link.

To transmit the data frame on the second link, the STA2 may perform a backoff operation after a time (time EMLSR Delay2+AIFS according to the AC of the data frame) elapses from a time of transmitting a reception response frame (e.g. BA frame) on the first link. The time EMLSR Delay2 may be a time required for switching the radio chain(s). The MediumSyncDelay timer on the second link may start after the time EMLSR Delay2 elapses from the time of transmitting the reception response frame on the first link. While the MediumSyncDelay timer operates, only a data frame transmission and reception procedure initiated by a specific control frame (e.g. short control frame, RTS frame) may be allowed.

When the reception response frame is transmitted using a single spatial stream, the radio chain may be switched before the time EMLSRDelay2 from a transmission end time of the reception response frame. When transmission of the reception response frame is completed, the second link may be in a state in which a channel sensing operation can be performed. In this case, the MediumSyncDelay timer on the second link may operate from the transmission end time of the reception response frame of the first link, which is a time when a channel sensing operation can be performed. A backoff operation for transmitting the data frame may be performed after an AIFS elapses from the transmission end time of the reception response frame on the first link, which is the time when a channel sensing operation can be performed.

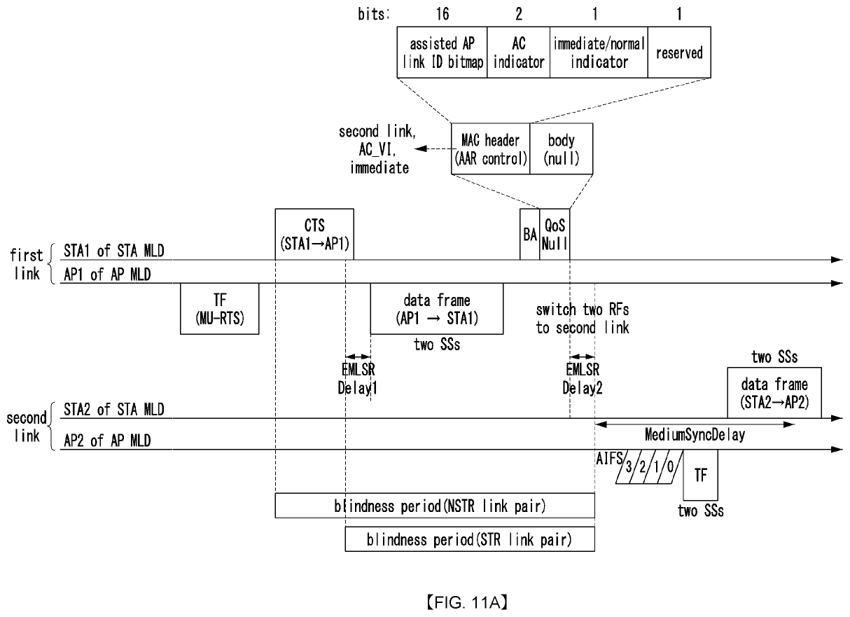

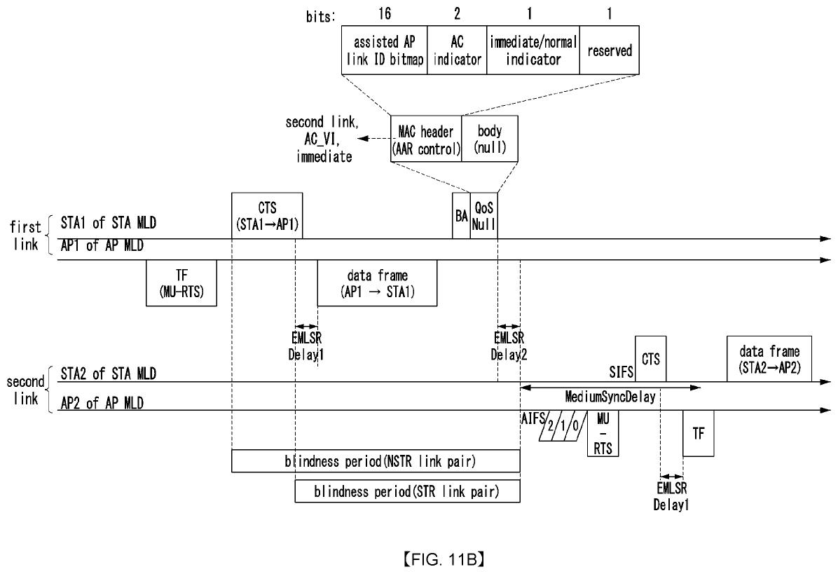

FIG. 11A is a timing diagram illustrating a fifth exemplary embodiment of a communication method in a device supporting the EMLSR mode, and FIG. 11B is a timing diagram illustrating a sixth exemplary embodiment of a communication method in a device supporting the EMLSR mode.

As shown in FIGS. 11A and 11B, AP MLD(s) and STA MLD(s) may support the EMLSR mode. The AP1 of AP MLD may transmit an MU-RTS frame on the first link. The STA1 of STA MLD may receive the MU-RTS frame from the AP1 on the first link and transmit a CTS frame on the first link in response to the MU-RTS frame. The AP1 may receive the CTS frame from the STA1 on the first link. According to the above-described operation, a frame transmission and reception procedure based on an EMLSR operation using multiple spatial streams (i.e. EMLSR communication procedure) may be initiated. Accordingly, a procedure for transmitting and receiving a frame (e.g. data frame, reception response frames) may be performed between the AP MLD and the STA MLD. The number of multiple spatial streams may correspond to the number of radio chains included in the STA MLD.

When a data unit (e.g. data, packet) exists in a queue of the STA MLD while performing the EMLSR communication procedure, a procedure for transmitting and receiving a data frame may be initiated using one link of multiple links after the EMLSR communication procedure. A TID may be determined according to an AC of the data frame, and a link on which the data frame is transmitted may be determined based on TID-to-link mapping. For example, the link on which the data frame is transmitted may be determined to be the second link.

The STA MLD1 (e.g. STA1) may inform the AP1 of information indicating that the data unit exists in the queue and/or information of a data frame. The above-described information may be configuration information for transmission of the data frame. The STA1 may transmit the above-described configuration information along with a BA frame. Since the size of a MAC header of the BA frame is fixed, it may be difficult to transmit additional information (e.g. configuration information for transmission of the data frame) through the MAC header. On the other hand, a MAC header of a QoS Null frame (e.g. QoS Null data frame) may include the additional information. Accordingly, the STA1 may transmit the QoS Null frame including the above-described configuration information (e.g. additional information) along with a BA frame. That is, the QoS Null frame may include the configuration information for transmission of the data frame (e.g. data unit). The BA frame and QoS Null frame may be configured in form of an aggregated (A)-MAC protocol data unit (MPDU) or as independent frames.

A duration of a transmit opportunity (TXOP) may be set by a duration field included in the MAC header of the MU-RTS frame. The TXOP may include a time required for transmitting a BA frame. However, in order to deliver information indicating that a data unit exists in the queue, transmission of a QoS Null frame with a short length may be allowed. That is, the duration of the TXOP may be extended for transmission of the QoS Null frame. To extend the duration of the TXOP, a duration field included in a MAC header of the CTS frame, which is a response for the MU-RTS frame, may indicate a period (i.e. extended TXOP) including the time required for transmitting the QoS Null frame. A value indicated by the duration field included in the MAC header of the CTS frame may be larger than the value indicated by the duration field included in the MAC header of the MU-RTS frame.

The duration of the TXOP may be set not to exceed a TXOP limit. The TXOP limit may be the maximum duration of the TXOP. The period including the time required for transmitting the QoS Null frame may not exceed the TXOP limit. If the time required for transmitting the QoS Null frame exceeds the TXOP limit, the QoS Null frame may not be transmitted. If extension of the duration of the TXOP is not allowed, the STA1 may transmit the QoS Null frame by performing a channel access procedure after transmission of the BA frame. That is, the STA1 may perform a backoff operation again to transmit the QoS Null frame on the first link, and when the backoff operation is completed, the STA1 may transmit the QoS Null frame.

Enhanced Distributed Channel Access (EDCA) parameter(s) used in the backoff operation for transmitting the QoS Null frame may be EDCA parameter(s) for an AC of the data frame for which assistance for transmission is requested from the AP MLD. That is, the EDCA parameter(s) used in the backoff operation for transmitting the QoS Null frame may be EDCA parameter(s) for an AC of the data unit existing in the queue of the STA MLD. When the AC of the data unit existing in the queue of the STA MLD is AC_VO, the STA1 may perform the backoff operation for transmitting the QoS Null frame using EDCA parameter(s) of AC_VO, and when the backoff operation is completed, the STA1 may transmit the QoS Null frame.

Alternatively, the AP may set a transmission duration (e.g. TXOP) set by the MU-RTS frame to be longer than an actual TXOP. Accordingly, the STA may transmit a BA frame configured along with the QoS Null frame in the specified TXOP.

A transmission end point of the reception response frame (e.g. BA frame or BA frame configured along with the QoS Null frame) may be earlier than an end time of the configured TXOP. When the transmission procedure ends within the TXOP, the AP may terminate the TXOP early.

An assisted AP request (AAR) control field included in the MAC header of the QOS Null frame may be used to deliver configuration information for the data unit existing in the queue of the STA MLD. In order to transmit the data unit existing in the queue of the STA MLD during a period corresponding to MediumSyncDelay, the STA1 may request assistance from the AP MLD by transmitting the QoS Null frame including the AAR control field (e.g. request transmission of a trigger frame for securing an earlier transmission opportunity).

The AAR control field may include at least one of an assisted AP link ID bitmap with a size of 16 bits, an AC indicator with a size of 2 bits, an immediate/normal indicator with a size of 1 bit, or a reserved bit with a size of 1 bit. The assisted AP link ID bitmap may indicate link(s) of AP(s) that will assist transmission of the data unit existing in the queue of the STA MLD among APs affiliated with the AP MLD. The order of bits included in the assisted AP link ID bitmap may be the order of the APs affiliated with the AP MLD. A bit set to 1 in the assisted AP link ID bitmap may indicate an AP (e.g. link) corresponding to the bit. The AC indicator may indicate the AC of the data unit existing in the queue of the STA MLD. The AC indicator may be referred to as an access category index (ACI). The ACI set to 00 may indicate AC_BE, the ACI set to 01 may indicate AC_BK, the ACI set to 10 may indicate AC_VI, and the ACI set to 11 may indicate AC_VO. The immediate/normal indicator may indicate a scheme of a procedure for transmitting and receiving the data frame. For example, in a first scheme, the procedure for transmitting and receiving the data frame may be initiated by a trigger frame. In a second scheme, the procedure for transmitting and receiving the data frame may be initiated by an MU-RTS frame.

In the exemplary embodiment of FIG. 11A, if the immediate/normal indicator included in the QoS Null frame indicates an immediate scheme (e.g. first scheme), this may indicate that the STA MLD can receive a normal control frame (e.g. trigger frame) immediately. The trigger frame may be referred to as ‘TF’. The STA MLD may switch two radio chains to a link (e.g. second link) indicated by the assisted AP link ID bitmap after transmitting the BA frame and QoS Null frame on the first link, and may receive a normal control frame (e.g. trigger frame) or data frame rather than a specific control frame (e.g. MU-RTS frame) on the second link.

In the exemplary embodiment of FIG. 11B, if the immediate/normal indicator included in the QoS Null frame indicates a normal scheme (e.g. second scheme), this may indicate that the STA MLD can receive a specific control frame (e.g. MU-RTS frame). The STA MLD may switch two radio chains to a link (e.g. second link) indicated by the assisted AP link ID bitmap after transmitting the BA frame and QoS Null frame on the first link, and may wait to perform a frame transmission/reception procedure initiated by a specific control frame (e.g. MU-RTS frame) on the second link. Alternatively, the STA MLD may wait to perform the frame transmission/reception procedure indicated by the specific control frame on the second link while operating two radio chains on the respective operating links (e.g. first link and second link). When the specific control frame is received on the second link, the STA MLD may operate the radio chains on the second link to perform the frame transmission and reception procedure.

The AP MLD (e.g. AP1) may receive the BA frame and QoS Null frame from the STA1 on the first link, and may identify the configuration information included in the QoS Null frame. The AP2 of AP MLD may perform a backoff operation for transmission of an MU-RTS frame on the second link using EDCA parameter(s) corresponding to the AC indicated by the ACI included in the QoS Null frame. Alternatively, the AP2 of AP MLD may perform a backoff operation using EDCA parameter(s) for transmission of a trigger frame (e.g. EDCA parameters corresponding to AC_VO or AC_VI).

When the MU-RTS frame is received on the second link, the STA MLD may switching the radio chain waiting to receive the MU-RTS frame on the first link to the second link. The STA2 of STA MLD may transmit a CTS frame in response to the MU-RTS frame and wait for reception of a frame. Considering that it takes a time of EMLSR Delay1 to switch the radio chain, the STA MLD may complete the switching operation of the radio chain before receiving the trigger frame. The AP2 of AP MLD may receive the CTS frame from the STA2, and may transmit the trigger frame after an SIFS elapses from a time of receiving the CTS frame. The trigger frame may be transmitted using one or two spatial streams. A preamble of the trigger frame may include information indicating the number of spatial streams used for transmission of the trigger frame. The STA2 of STA MLD may receive the trigger frame from the AP2, and may identify a radio resource indicated by the trigger frame. The STA2 may transmit a data frame including the data unit existing in the queue using the radio resource indicated by the trigger frame after an SIFS elapses from the time of receiving the trigger frame.

The AAR control field included in the QoS Null frame may not indicate a length of the data unit existing in the queue. Therefore, the STA1 may transmit the QoS Null frame including a buffer status report (BSR) in an A-control. The BSR may indicate the length of the data unit existing in the queue of the STA MLD. The AP MLD may receive the QoS Null frame from the STA MLD and identify the BSR included in the QoS Null frame. The AP MLD may allocate a radio resource by using the trigger frame so that the STA MLD can transmit the entire data unit with the length indicated by the BSR or can transmit the data unit with the length indicated by the BSR as much as possible. That is, the AP MLD may allocate an accurate amount of radio resource to the STA MLD based on the BSR.

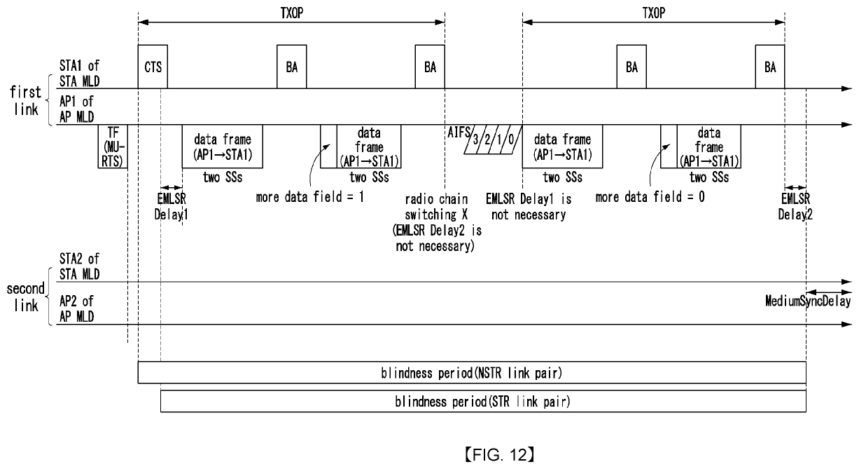

FIG. 12 is a timing diagram illustrating a seventh exemplary embodiment of a communication method in a device supporting the EMLSR mode.

As shown in FIG. 12, AP MLD(s) and STA MLD(s) may support the EMLSR mode. When a data frame to be transmitted to the STA MLD exists, the AP MLD may initiate a procedure of transmitting and receiving a data frame by transmitting an MU-RTS frame on one link among multiple links. The AP MLD may set a duration of a TXOP within a TXOP limit according to an AC of the data frame and transmit an MU-RTS frame including a MAC header including a duration field indicating the duration of the TXOP. The STA MLD may receive the MU-RTS frame from the AP MLD, and identify the duration field included in the MAC header of the MU-RTS frame. STA(s) that are not recipient(s) of the data frame among STAs affiliated with the STA MLD may set a NAV based on a value of the duration field.

The AP1 of AP MLD may transmit a plurality of data frames with the same AC within the TXOP. The AP1 may transmit the plurality of data frames using spatial streams corresponding to the number of radio chains. The STA MLD (e.g. STA1) may receive the multiple data frames with multiple spatial streams. The number of the multiple spatial streams may correspond to the number of radio chains included in the STA MLD. An additional data unit to be transmitted to the STA MLD may exist in the AP MLD's queue. The additional data unit may be a remaining data unit that has not been transmitted in a previous transmission procedure. An AC of a data unit transmitted in the previous transmission procedure may be the same as an AC of the additional data unit. Alternatively, the additional data unit may be a new data unit to be transmitted to the STA MLD (e.g. STA1). The AC of the data unit transmitted in the previous transmission procedure may be the same or different from the AC of the additional data unit.

If a data unit to be transmitted to the STA MLD (e.g. STA1) during the TXOP exists in the queue of the AP MLD, the AP1 of AP MLD may set a ‘more data’ field included in a MAC header of the data frame to 1, and transmit the data frame to the STA1 of STA MLD. The STA1 of the STA MLD may receive the data frame from the AP1, and may identify that the ‘more data’ field included in the MAC header of the data frame is set to 1. That is, the STA1 may determine that a data unit to be transmitted to the STA1 exists in the queue of the AP MLD based on the value of the more data field. The STA1 may transmit a reception response frame (e.g. BA frame) for the data frame to the AP1. Afterwards, the STA MLD may not perform an operation of switching the radio chain to the second link and may maintain the radio chain on the first link.

In order to transmit a data unit existing in the queue to STA1 of the STA MLD, the AP1 of the AP MLD may perform a backoff operation after an AIFS elapses from a time of receiving the reception response frame. When the backoff operation succeeds, the AP1 of the AP MLD may transmit the data frame to the STA1 by using multiple spatial streams (e.g. two spatial streams) supported by the STA MLD without transmitting an MU-RTS frame. The STA1 of STA MLD may receive the data frame using multiple spatial streams. The STA MLD may identify that an additional data frame is to be transmitted based on the more data field. Accordingly, the STA MLD may not switch the radio chains to another link. In this case, a time (e.g. EMLSR Delay1 and/or EMLSR Delay2) required for switching one radio chain to another link may not be necessary.

When the ‘more data’ field included in the MAC header of the data frame received from the AP1 of AP MLD is set to 0, the STA MLD may determine that there is no data frame to be transmitted by the AP MLD. In this case, the radio chains may wait for reception of MU-RTS frames on multiple links. Accordingly, the STA1 of the STA MLD may switch the radio chain to another link after receiving a reception response frame (e.g. BA frame). It may take a time EMLSR Delay2 to switch the radio chain to another link. While the data frame transmission and reception procedure using multiple spatial streams is performed between the AP1 of AP MLD and the STA1 of STA MLD, the second link may be in a state not capable of performing a reception operation. That is, a channel sensing operation cannot be performed on the second link. Accordingly, a period from a time at which the STA MLD transmits the reception response frame to a time at which the radio chain is switched to the second link may be a blindness period. The blindness period may include a time required for transmitting the data frame including the ‘more data’ field set to 1 and a time required for performing a backoff operation.

The exemplary embodiments of the present disclosure may be implemented as program instructions executable by a variety of computers and recorded on a computer-readable medium. The computer-readable medium may include a program instruction, a data file, a data structure, or a combination thereof. The program instructions recorded on the computer-readable medium may be designed and configured specifically for the present disclosure or can be publicly known and available to those who are skilled in the field of computer software.

Examples of the computer-readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

1. A method of a first device, comprising:
receiving a first data frame from a second device on a first link using multiple spatial streams;
transmitting a reception response frame for the first data frame to the second device on the first link;
transmitting a third data frame including configuration information for transmission of a second data frame to the second device on the first link; and
transmitting the second data frame to the second device on a second link based on the configuration information.

2. The method according to claim 1, further comprising:
receiving a multi user (MU)-request-to-send (RTS) frame from the second device on the first link; and
transmitting a clear-to-send (CTS) frame to the second device in response to the MU-RTS frame on the first link,
wherein the first data frame is received after transmission of the CTS frame.

3. The method according to claim 2, wherein a reception operation is not performed on the second link during a first period from a time of transmitting the CTS frame to a completion time of switching one or more radio chains of the first device, and the first period includes a time required for transmitting CTS frame, a time required for receiving the first data frame, a time required for transmitting the reception response frame, a time required for transmitting the third data frame and a time required for switching the one or more radio chains.

4. The method according to claim 1, wherein the reception response frame and the third data frame are configured in form of an aggregated (A)-medium access control (MAC) protocol data unit (MPDU), and the third data frame is a quality of service (QOS) Null frame.

5. The method according to claim 1, wherein the configuration information includes one or more selected from information indicating a link on which the second data frame is transmitted, information indicating an access category (AC) of the second data frame and information indicating a scheme of a transmission/reception procedure of the second data frame.

6. The method according to claim 5, further comprising: in response to that the information in the configuration information indicates that the scheme of the transmission/reception procedure of the second data frame is a first scheme, receiving a trigger frame from the second device on the second link, wherein the transmission/reception procedure of the second data frame is initiated by the trigger frame.

7. The method according to claim 5, further comprising:
in response to that the information in the configuration information indicates that the scheme of the transmission/reception procedure of the second data frame is a second scheme, receiving an MU-RTS frame from the second device on the second link; and
transmitting a CTS frame for the MU-RTS frame to the second device on the second link,
wherein the transmission/reception procedure of the second data frame is initiated by the MU-RTS frame.

8. A method of a second device, comprising:
transmitting a first data frame to a first device on a first link using multiple spatial streams;
receiving a reception response frame for the first data frame from the first device on the first link;
receiving a third data frame including configuration information for transmission of a second data frame from the first device on the first link; and
receiving the second data frame from the first device on a second link based on the configuration information.

9. The method according to claim 8, further comprising:
transmitting a multi user (MU)-request-to-send (RTS) frame to the first device on the first link; and
receiving a clear-to-send (CTS) frame for the MU-RTS frame from the first device on the first link,
wherein the first data frame is transmitted after reception of the CTS frame.

10. The method according to claim 9, wherein a reception operation of the first device is not performed on the second link during a first period from a time of receiving the CTS frame to a completion time of switching one or more radio chains of the first device, and the first period includes a time required for receiving the CTS frame, a time required for transmitting the first data frame, a time required for receiving the reception response frame, a time required for receiving the third data frame and a time required for switching the one or more radio chains.

11. The method according to claim 8, wherein the reception response frame and the third data frame are configured in form of an aggregated (A)-medium access control (MAC) protocol data unit (MPDU), and the third data frame is a quality of service (QOS) Null frame.

12. The method according to claim 8, wherein the configuration information includes one or more selected from information indicating a link on which the second data frame is transmitted, information indicating an access category (AC) of the second data frame and information indicating a scheme of a transmission/reception procedure of the second data frame.

13. The method according to claim 12, further comprising: in response to that the information in the configuration information indicates that the scheme of the transmission/reception procedure of the second data frame is a first scheme, transmitting a trigger frame to the first device on the second link, wherein the transmission/reception procedure of the second data frame is initiated by the trigger frame.

14. The method according to claim 12, further comprising:
in response to that the information in the configuration information indicates that the scheme of the transmission/reception procedure of the second data frame is a second scheme, transmitting an MU-RTS frame to the first device on the second link; and
receiving a CTS frame for the MU-RTS frame from the first device on the second link,
wherein the transmission/reception procedure of the second data frame is initiated by the MU-RTS frame.

15. A method of a first device, comprising:
receiving a first data frame from a second device on a first link using multiple spatial streams;
transmitting a first reception response frame for the first data frame to the second device on the first link; and
in response to that information included in the first data frame indicates that a second data frame to be transmitted to the first device exists in the second device, performing a reception operation on the first link without switching radio chain(s) of the first device.

16. The method according to claim 15, further comprising:
receiving the second data frame from the second device on the first link using the multiple spatial streams;
transmitting a second reception response frame for the second data frame to the second device on the first link; and
in response to that information included in the second data frame indicates that a third data frame to be transmitted to the first device does not exist in the second device, performing a reception operation on multiple links by switching radio chain(s) of the first device.

17. The method according to claim 15, wherein a reception operation of the first device is not performed on the second link while a data frame transmission/reception procedure using the multiple spatial streams is performed on the first link.

18. The method according to claim 15, further comprising:
receiving a multi user (MU)-request-to-send (RTS) frame from the second device on the first link; and
transmitting a clear-to-send (CTS) frame for the MU-RTS frame to the second device on the first link,
wherein a transmission/reception procedure of the first data frame is initiated by the MU-RTS frame.

19. The method according to claim 15, wherein a control frame for initiating a transmission/reception procedure of the second data frame is not used, and the second data frame is transmitted when a backoff operation succeeds in the second device.

20. The method according to claim 15, wherein a number of the multiple spatial streams corresponds to a number of radio chains included in the first device.
